(19) United States
(12) Patent Application Publication
(10) Pub. No.: US 2026/0060278 A1
(43) Pub. Date: Mar. 5, 2026

(54) ANIMAL-FREE SUBSTITUTE FOOD PRODUCTS COMPRISING CELLULASE

(71) Applicant: FORMO BIO GMBH, Berlin (DE)

(72) Inventors: Joshua Adam LIVERMORE, Berlin (DE); Mara Elisa REIFENRATH, Berlin (DE); Irene Barba COBOS, Berlin (DE); Lena MERTES, Berlin (DE); Monika BRUCKNER-GUEHMANN, Berlin (DE); Alexander WESTPHAL, Berlin (DE)

(21) Appl. No.: 19/104,533

(22) PCT Filed: Aug. 18, 2023
(86) PCT No.: PCT/EP2023/072863

§ 371 Date: Feb. 18, 2025

(30) Foreign Application Priority Data
Aug. 18, 2022 (AU) 2022902352
Aug. 31, 2022 (AU) 2022902505
Dec. 23, 2022 (GB) 2219695.0
Dec. 23, 2022 (GB) 2219701.6

(51) Int. Cl. A23J 3/22; A21D 2/26; A23C 11/10; A23C 20/02; A23L 15/00; A23L 29/00

(52) U.S. Cl. CPC A23J 3/22; A21D 2/264; A23C 11/10; A23C 20/02; A23L 15/35; A23L 29/06

(57) ABSTRACT

A method for producing a substitute food product, such as a dairy product, such as cheese or yoghurt, or a substitute egg product, using a cellulase enzyme. The cellulase enzyme may be at least partially denatured or may be present in an amount of 3 g/100 g protein.

The present invention relates to a method for producing a substitute food product, such as a dairy product (such as cheese or yoghurt), or an egg replacement composition. The invention further extends to a substitute food product, such as a substitute cheese or egg product, made using the method of the invention and to compositions used to produce the substitute food products.

### BACKGROUND OF THE INVENTION

Protein is a key nutritional requirement and forms a key component of the human and animal diet. Proteins can be animal derived (for example, meat, fish, milk or eggs) or can also be sourced from plants, for example legumes, or microbes.

Cheese is typically made out of milk or milk-derived ingredients. Milk production is a resource intensive method and has a negative effect on the environment, leading to a questionable sustainability of cheese made from milk or milk derived ingredients. In fact, cheese is the third most unsustainable animal product globally in terms of greenhouse gas emissions per kg of product.

Hence, great efforts are undertaken to produce substitute dairy products, such as cheese-like and other substitute dairy products of vegan source (including milk and yogurt-substitute products), i.e., without the use of milk and other animal-derived ingredients. However, to date, the use of vegan ingredients, like plant proteins, results in products that lack the organoleptic properties of cheese. Further, the nutritional quality of these products is also low due to the low protein content and/or low nutritional value of the vegetable proteins compared to animal-derived proteins. The plant-based alternatives not resembling the organoleptic properties of the dairy original and/or having low nutritional quality is one of the major reasons why the consumption of dairy cheese has not been slowed down by these plant-based products.

Eggs, particularly from avian species such as chickens, while high in protein, include components that are allergenic or are considered unhealthy for certain groups of people. However, eggs have several desirable functional attributes that permit the use of egg in preparing a wide variety of egg-based food products of pleasurable taste/flavour and texture, including emulsions, batters, doughs, baked/cooked goods, and the like. Eggs are useful in these products because they contribute to processes such as gelling/thickening/coagulating, foaming/leavening, emulsifying, and water binding. Therefore, eggs are considered essential ingredients of many commonly consumed food products, imparting or contributing to volume, texture, emulsification, shape, taste/flavour, cooking stability, processing tolerance, and shelf life.

There is an interest in vegan egg replacers. Known prior art egg replacers are, for example, based on mung bean protein isolate, chickpea flour, pea protein or lupin protein isolate. Companies producing such egg replacers are include Greenforce, Just Egg, Rewe Bio, Plant-B. Aquafaba from commercially canned chickpeas can also be used as a potential egg replacer, see Institute of Food Science and Technology, 2019 Oct. 24 which discusses the recipe optimisation and storage stability of Aquafaba in vegan mayonnaise. Likewise, WO2022124988 discloses an egg yolk replacer.

There is a need for an egg replacer that provides similar nutritive content, similar functional, taste, flavour, and organoleptic attributes, and fewer or none of the undesired attributes. It is an object of the current invention to provide an improved egg replacer.

Hence, there is a need for the provision of animal-free substitute food products, including dairy and egg substitutes, in particular substitute products resembling the organoleptic properties of the corresponding animal-based food.

### SUMMARY OF THE INVENTION

The inventors have found that a denatured cellulase enzyme can be used in the product as an ingredient, for example, at a minimum level of 3% (w/w of protein) within a substitute food product. Optionally, the cellulase enzyme can be present as the main protein constituent of the substitute food product. The cellulase enzyme allows the formation of a product with acceptable organoleptic properties as well as having suitable physical characteristics. In an egg replacer product (which is intended for combination with other ingredients before cooking), the enzyme may be denatured as part of the cooking process itself.

Optionally, the cellulase enzyme is present in an amount of about 0.01 g/L to about 1000 g/L inclusive, typically between 10 g/L to 450 g/L, inclusive, more specifically between 60 g/L and 350 g/L, inclusive.

The inventors have found that a substitute food product can be formed by using a cellulase enzyme as an ingredient within the substitute food product. Where we refer to the enzyme being present as an “ingredient”, we mean that the enzyme is not present as a biocatalyst to break down other biomolecules or as dietary supplements but is rather used for its structural or nutritional properties. Thus, the cellulase enzyme is subjected to a process step which process step converts the cellulase enzyme into at least one converted protein having a structural function. Since the cellulase enzyme is not being used as a biocatalyst, it can conveniently be denatured, optionally during cooking of the food product itself. Optionally, the cellulase enzyme is heat treated prior to or during such that it is suitable for human consumption. The term “cellulase enzyme” is used herein to refer to a wild type cellulase enzyme or to variants thereof, which have an amino acid sequence with at least 80% sequence identity relative to the amino acid sequence of a wild type cellulase enzyme. Optionally any variant has more than 80% sequence identity to a wild type cellulase enzyme, for example has 85% or more, 90% or, 95% or more or 98% or more sequence identity to the amino acid sequence of a wild type cellulase enzyme.

More specifically, the inventors have found that it is possible to obtain a curd or emulsified composition by using at least one cellulase enzyme to produce an animal-free substitute food product resembling the organoleptic or other desirable properties of equivalent food products, for example traditional dairy products such as cheese. Optionally, the cellulase enzyme is denatured using heat-treatment, which further ensures that it is suitable for human consumption.

The at least one cellulase enzyme may be treated to render it partially or substantially devoid of its catalytic function prior to or during the process of forming the food product. Such treatment may be by way of hydrolysis (pH-based hydrolysis or enzymatic hydrolysis), heat-treatment, or by mechanical shearing to partially or fully denature the catalytic activity of the cellulase enzyme. The at least partially denatured cellulase enzyme is then suitable for use as a structural ingredient for producing a substitute food product. The treatment may be by way of enzymatic hydrolysis, for example using a protease and/or by means of heat treatment.

The invention thus extends to a substitute dairy product wherein the main protein constituent is at least one partially or fully denatured cellulase enzyme.

According to another aspect of the invention, there is provided a cellulase enzyme which, when converted in accordance with an aspect of the invention, is rendered as a protein component having a desirable attribute. By “desirable attribute” is meant an attribute that may be useful in making a food-like or substitute food product, such as an egg replacer.

In a further aspect, the present invention provides a process of forming a substitute egg product, wherein at least one cellulase enzyme is mixed with water to form a mixture and said mixture is homogenised with a fat, wherein said cellulase enzyme provides at least 5 g/100 g protein of the product. Optionally, the cellulase enzyme is mixed with a carbohydrate source together with the water, for example a seed mucilage or a flour. Instead of a seed mucilage, fibres, such as flaxseed fibre, hydrocolloids, modified starches or soluble fibres such as β-glucan, xanthan gum, pectin and the like can also be used. Optionally a fat can be added to the mixture and homogenized to form the substitute egg product. Optionally other flavourings or colorants can be added, as described below with regard to the composition.

The invention thus also extends to a substitute egg product wherein the main protein constituent is at least one partially or fully denatured cellulase enzyme.

The inventors have found that the cellulase enzyme (which may be partially or fully denatured) can be used to provide improved structural or nutritional value within the animal-free substitute food products of the invention.

### FIGURES

FIG. 1 (a) shows the gelation of cellulase/beta-glucanase (product A) at different pH values and salt concentrations. Top row: no salt, bottom row: 1% NaCl (w/w). From left to right: pH 5.0, 5.5, 6.6; (b) shows the gelation of cellulase/beta-glucanase (product B) at different pH values and salt concentrations. Top row: no salt, bottom row: 1% NaCl (w/w). From left to right: pH 5.0, 5.5, 6.6;

FIG. 2 shows the gelation of cellulase and hemicellulase at different pH values and salt concentrations;

FIG. 3 shows a substitute cheese product made as described in the Example.

FIG. 4 shows a substitute joghurt product made as described in the Example;

FIG. 5 shows Amplitude-sweeps of cow-milk based Joghurt (top) and substitute joghurt made of Cellulase A (bottom);

FIG. 6 shows a substitute fresh cheese product made as described in the Example: Fresh cheeses made of Cellulase enzyme (left) and Glucocellulase enzyme (right);

FIG. 7 shows a substitute egg product made as described in the Example.

### DETAILED DESCRIPTION OF THE INVENTION

Dairy milk products and eggs form a significant part of a western diet. Typically, most animal-free food products rely heavily on the inclusion of plant proteins. The process of separating plant proteins from associated carbohydrates and other molecules is inefficient and expensive. Therefore, known animal-free egg replacement compositions produced with plant proteins suffer from intrinsically poor performance due to co-extracted compounds that negatively affect taste, smell, and texture. The proteins used in these products are structural in nature.

Typically, cheese products are made using either animal milk or using protein and fat extracts from plants. To date, most animal-free substitute dairy products rely heavily on the inclusion of plant proteins. The process of separating plant proteins from associated carbohydrates and other molecules is inefficient and expensive. Therefore, an animal-free substitute cheese (for example) produced with plant proteins suffers from intrinsically poor performance due to co-extracted compounds that negatively affect taste, smell, and texture. Surprisingly, the Applicant has found that it is possible to use cellulase enzyme which is generally used in the animal and human food industries (but which has previously been employed only as a biocatalyst to break down carbohydrate or as dietary supplements and has not been used for their structural or nutritional properties), as a major ingredient to create substitute food products such as substitute dairy products. It was surprising that the cellulase enzyme could serve the same structural purpose as animal or plant based globular proteins. Optionally, the cellulase enzyme can be treated to render it suitable for human consumption, for example can by heat treatment. Specifically, heat treatment of the cellulase enzyme produces a cheese-like gel, emulsion, or curd, which was further treated to render a substitute cheese or cheese-like product, specifically a vegan or animal-free substitute cheese.

It was then found that the gel, emulsion or curd formed could also be used to form other substitute dairy products, such as yoghurt, and also to form other substitute food products, such as substitute egg products.

Surprisingly, the Applicant has found that it is possible to treat or manipulate globular enzymes, specifically cellulase enzyme, that are generally used in the animal and human food industries (but which have previously been employed only as biocatalysts to break down other biomolecules or as dietary supplements and have not been used for their structural properties) to create substitute-egg food products, such as an animal-free egg replacement composition, egg-based food product or egg-white substitute. It was, therefore, surprising that cellulase enzyme could provide the required structure as natural egg proteins to form egg-like food products, egg-white substitute or an egg replacement composition for use in egg-based food products or compositions for such products. Specifically, heat treatment of the cellulase enzyme produces an egg-like gel or emulsion product which could be used to form an (optionally vegan or animal-free) egg replacement composition, or an (optionally vegan or animal-free) egg-like product, such as scrambled eggs.

To successfully deliver a substitute-egg food product, the technical properties of the protein are important for providing the characteristics of the final product, in conjunction with the ability for the protein to be produced in sufficient quantity in a sustainable way. At the same time, the protein should deliver health (nutrition) benefits similar to egg proteins.

Egg white contains many functionally important proteins; Ovalbumin (54%), ovotransferrin (12%), ovomucoid (11%), ovomucin (3.5%), and lysozyme (3.5%). However, production of all of these proteins using genetic engineering and precision fermentation in order to simulate an animal-free egg replacement product is very challenging and costly. Accordingly, finding a single protein which can deliver one or more of the technical, nutritional and/or organoleptic properties of egg proteins as well as egg experience to consumers is important. Cellulase has the ability to form a gel formation (coagulate) upon heating.

Enzymes for biocatalysis, such as cellulase enzyme, are used almost exclusively for a precisely specified catalytic function. In contrast, in the present invention, the cellulase enzyme is used to provide the main protein constituent (i.e., main protein nutrition) and an improved structure to a substitute food product, such as a substitute cheese, or egg replacer. Advantageously, the cellulase enzyme used herein is already generally regarded as safe (“GRAS”) due to its extensive use in the food industry.

According to a first aspect of the invention there is provided a method for the production of a substitute food product, the method comprising the steps of:
i. providing at least one cellulase enzyme;
ii. subjecting the at least one cellulase enzyme to one or more process steps to at least partially denature the cellulase enzyme or providing the cellulase enzyme in the product in an amount of at least 3 g/100 g protein; and
iii. incorporating said cellulase enzyme into a composition to form a substitute food product.

The term “cellulase enzyme” is used herein to refer to a wild type cellulase enzyme or to variants thereof, which have an amino acid sequence with at least 80% sequence identity relative to the amino acid sequence of a wild type cellulase enzyme. Optionally any variant has more than 80% sequence identity to a wild type cellulase enzyme, for example has 85% or more, 90% or, 95% or more, or 98% or more sequence identity to the amino acid sequence of a wild type cellulase enzyme.

Optionally, the cellulase enzyme used within the present invention is recombinantly produced, that is expressed under controlled conditions using a heterologous host cell, for example in a genetically modified organism (GMO), such as a micro-organism (GMO). Optionally, the cellulase enzyme is expressed naturally from a host cell. The host cell can be a fungus, for example can be Trichoderma reesei. Optionally, the cellulase enzyme is naturally produced by plants. Optionally the cellulase enzyme is naturally produced by micro-organisms. Optionally, the cellulase enzyme can be provided in the form of a crude or purified ferment.

The cellulase enzyme used in the present invention can be neutrally flavoured and can be manipulated to form gels, emulsions, or curds with a texture and mouthfeel that can be optimised through modification of process conditions know to those skilled in the field of the invention. The cellulase enzyme may be commercially available in the marketplace, for example beta-glucanase, β-1,4-endoglucanase, or cellulase. The availability of the cellulase presents an opportunity for ameliorating the sub-optimal economics involved in making substitute food products, for example making substitute dairy products from recombinantly produced dairy proteins.

Cellulase degrade cellulose to glucose. Cellulase hydrolyzes (1,4)-beta-D-glucosidic linkages in cellulose and other beta-D-glucans. There are three types of cellulase enzymes: endoglucanases, exocellulase enzymes, and processive endoglucanases. Cellulase includes three enzymes including β-1,4-endoglucanase, cellobiohydrolase, and β-glucosidase. Cellulase enzymes, including β-glucanase, cellobiohydrolase, and β-glucosidase, act synergistically to hydrolyse cellulose. Trichoderma reesei's genome encodes 10 cellulase enzymes and 16 hemi-cellulase enzymes. It produces two exoglucanases (CBH I and CBH II), about eight endoglucanases (EGI-EGVIII), and seven β-glucosidases (BG I-BG VII).

Hemicellulases are enzymes that break down material typically associated with or attached to cellulose. This category includes xylanase, arabinoxylanase, beta-glucanase, beta-mannanase, pectinase, arabinase, pectin methylesterase, pectin lyase, and polygalacturonases.

In the present invention, the term cellulase enzyme is intended to include cellulase enzyme and hemicellulase enzyme.

The invention is based on the realisation that cellulase enzyme, can be used to produce compositions that exhibit a similar taste, aroma, and mouth feel as equivalent food products, for example dairy products such as cheese made using animal-produced milk (“traditional milk” or “traditional dairy products” when animal milk is used to make products such as cheese). The present invention therefore provides compositions, methods of making the compositions, and kits including cellulase enzyme, compositions, curds, and mixtures useful for making these substitute food products.

The present invention includes the use of a cellulase enzyme produced through precision fermentation which is converted from a protein having a catalytic activity (i.e., an enzyme) into a protein providing a structural function. The invention also provides a protein with a structural function produced using the method of the invention. As such, the invention extends to, a cellulase enzyme treated in accordance with the method of the invention to render it suitable for inclusion in a substitute food product as a structural component of the food product, i.e., to denature it at least partially to render it suitable for inclusion in a food product as a structural component of the food product.

The substitute food products or compositions of the invention have a similar taste, mouth feel, aroma, and nutritional value as compared to equivalent products or compositions made using animal products.

For example, the substitute dairy products or compositions of the invention have a similar taste, mouth feel, aroma, and nutritional value as compared to equivalent products or compositions made using animal-produced milks.

Additionally, the inventors have found that it is possible to obtain an egg replacement composition (“egg replacer”) which can be used with other ingredients to form an egg-based food product or egg-based food product composition. The egg replacement composition can be formed by using at least one cellulase enzyme. The egg replacement composition formed is preferably an animal-free product. The egg replacement composition formed preferably exhibits the organoleptic or other desirable properties of avian eggs.

The invention thus extends to an egg-based food product, that is a food product in a form which is ready to eat comprising the egg replacement composition of the invention.

The invention also extends to an egg-based food product composition comprising the egg replacement composition of the invention, that is a composition for a food product which requires cooking to be in a form which is ready to eat. Thus, the present invention provides a food product or food product composition which comprises the egg replacement composition of the present invention together with at least one other ingredient to form an egg-based food product or an egg-based food product composition.

In one embodiment of the invention, a beta glucanase has been used. In one embodiment of the invention, a hemicellulase enzyme has been used.

Optionally, the substitute food product, for example egg replacer composition/product comprises an cellulase enzyme, with the cellulase enzyme providing a minimum level of protein of 3% (w/w of protein), optionally with at least 5% (w/w protein), optionally with at least 10% (w/w protein), for example at least 20% (w/w protein) of the food product. Optionally the cellulase enzyme can be the main protein constituent of the food product.

The term “main protein constituent” refers to the ingredient which provides the majority protein content within the product of the invention compared to any other ingredient or sum of other ingredients. For example, the “main protein constituent” can provide more that 50% (w/w) of the protein content within the product, for example at least 80% (w/w), for example at least 90% (w//w) of the of the protein content within the product.

The term “substitute dairy product” refers to a composition that resembles or is equivalent to a product made using a dairy milk or a dairy milk component. In particular, the substitute dairy product will resemble or be equivalent in terms of one or more of: taste, aroma, flavour, mouthfeel, organoleptic qualities, colour, and the like to a product made using dairy milk or a dairy milk component. Thus, the term “substitute dairy product” as used herein means a product resembling a traditional dairy product, but made with proteins produced by processes not involving mammals. For example, the proteins used can be plant-based proteins or can be proteins expressed by a micro-organism or, more preferably, are recombinantly expressed proteins, for example are proteins which are expressed using heterologous microbial host cells. The terms “synthetic dairy product” or “synthetic cheese product” can be used interchangeably with the term “substitute dairy product”.

The term “animal-produced milk” refers to a milk which has been obtained from a female mammal such as a cow, goat, sheep, camel, human etc. by lactation.

The term “isolated” protein or “isolated” enzyme refers to a protein or enzyme which is substantially separated from other cellular components that naturally accompany the native protein or enzyme in its natural host cell.

The term “animal-free” refers to a component which has not been obtained or produced from an animal, but excludes a recombinantly-produced protein, even where the recombinantly produced protein has the same amino acid sequence as a wild type equivalent.

“Heat treated” means that the cellulase enzyme has been treated with heat to a temperature sufficient to reduce the likelihood of bacterial contamination, thereby rendering the cellulase enzyme suitable for use within a foodstuff. A “heat treated” cellulase enzyme may also be at least “partially denatured”.

“Partially denatured” means that the protein structure of the cellulase enzyme has been irreversibly changed so as to impair its original catalytic activity by at least 50%, preferably by at least 75% relative to the activity of the untreated cellulase enzyme.

“Totally denatured” or “fully denatured” means that the protein structure of the cellulase enzyme has been irreversibly changed so as to reduce its catalytic activity to 10% or less, for example to 5% or less. Optionally the catalytic activity of the cellulase enzyme has been completely lost.

The term “lipids” means one or more molecules that include a fatty acyl group (e.g., saturated or unsaturated acyl chains). For example, the term “lipids” includes fats, oils, phospholipids, free fatty acids, monoglycerides, diglycerides, and triglycerides. Non-limiting examples of lipids are described herein and include sunflower oil, coconut oil, rapeseed oil, palm fat, tributyrin, mono- and di-glycerides, free fatty acids, and phospholipids, cultured oils or fats, or microbially-produced or microbially-derived oils or fats. Non-animal fats or oils are an option and refer to plant or microbial, fungal or recombinantly produced fats or oils. Additional examples of lipids are known in the art.

The term “sweetening agent” means a saccharide (e.g., a monosaccharide, a disaccharide, or a polysaccharide) or an artificial sweetener (e.g., a small molecule artificial sweetener or a protein artificial sweetener) that, when added to a composition, makes the composition taste sweet when ingested by a mammal, such as a human. Non-limiting examples of sweetening agents are described herein. Additional examples of sweetening agents are known in the art.

The term “ash” is a term known in dairy science and refers to one or more ions, elements, minerals, and/or compounds that can be found in an animal-produced milk. Non-limiting examples of the ions, elements, minerals, and compounds that are found in an animal-produced milk and which are covered by the term “ash” are described herein. Additional ions, elements, minerals, and compounds that are found in an animal-produced milk are also known in the art. The term “ash” as used herein refers to residue remaining after the product has been burned for analysis includes minerals, such as salts. In some embodiments, the minerals can be salts or ions or one or more of the following: sodium, potassium, calcium, magnesium, phosphorus, iron, copper, zinc, chloride, manganese, selenium, iodine. The term “ash” also includes, retinol, carotene, and other vitamins (such as vitamin D, vitamin E, vitamin B12, thiamine, and riboflavin). As used herein, the term “ash” also includes anions. Examples of such anions include one or more of the following: phosphate, citrate, sulphate, carbonate, and chloride.

The term “colour balancing agent” or “colouring agent” means an agent added to a composition to modulate the colour of the composition, e.g., to make the colour of the composition appear more similar to an equivalent product made using animal-produced milk or avian egg. Non-limiting examples of colour balancing agents or colouring agents include 3-carotene and annatto. Other examples of colouring balancing agents are known in the art. Optionally, the colour balancing agent or a colouring agent can be produced by or obtained from a plant.

Desirably, the substitute food products and compositions of the present invention exhibit functional characteristics and organoleptic properties of an equivalent food-based product. In some embodiments, the substitute food products and compositions of the present invention have a nutritional profile similar to an equivalent conventional food product, and replicates one or more, if not all, of the core functionalities thereof.

The term “core functionalities” refers to the sensory, chemical, biochemical, or mechanical characteristics of a traditional food product. The term “core functionalities”, includes but is not limited to: flavour, taste, appearance, nutritional value, handling and mouthfeel, desired density, structure, texture, elasticity, springiness, coagulation, binding, leavening, aeration, foaming, creaminess, and emulsification.

The term “flavour” refers to the taste and/or the aroma of a food or drink.

As used herein, the term “predominantly” or variations thereof will be understood to mean, for instance, a) in the context of fats the amount of a particular fatty acid composition relative to the total amount of fatty acid composition; b) in the context of protein the amount of a particular protein composition (e.g cellulase enzyme relative to the total amount of protein composition (e.g., α-, β-, and κ-casein).

The term “about,” “approximately,” or “similar to” means within an acceptable error range for the particular value as determined by one of ordinary skill in the art, which can depend in part on how the value is measured or determined, or on the limitations of the measurement system. It should be understood that all ranges and quantities described below are approximations and are not intended to limit the invention. Where ranges and numbers are used these can be approximate to include statistical ranges or measurement errors or variation. In some embodiments, for instance, measurements could be plus or minus 10%.

According to one aspect of the invention there is provided a method for the production of a substitute food product, the method comprising the steps of:
providing at least one cellulase enzyme;
and incorporating said at least one cellulase enzyme into a composition to form a substitute food product, and wherein said cellulase enzyme is subjected to one or more process steps to at least partially denature the cellulase enzyme during formation of the substitute food product.

In one embodiment, the cellulase enzyme is denatured. The cellulase enzyme is therefore caused to gel or coagulate during denaturisation. Optionally, the cellulase enzyme will be in a solution or suspension having a pH of about 5.0 to about 7.2 (e.g., about 6.2 to about 6.8) prior to gelling/coagulation.

The step of at least partially denaturing the cellulase enzyme may take place before or after the cellulase enzyme is added to other ingredients to form the composition.

Optionally, the at least partially denatured enzyme cellulase enzyme comprises at least 3% by weight of protein in the substitute food product, for example at least 5% by weight, for example at least 7% (w/w protein), for example up to 10% (w/w protein) such as 7 to 10% (w/w protein) of the substitute food product.

Optionally, the cellulase enzyme is the main protein constituent of the substitute food product (i.e., can comprise at least 10% (w/w protein), for example 20% (w/w protein) or more within the substitute food product, for example from 20 to 50% (w/w protein), for example from 30 to 50% (w/w protein). Specifically, the cellulase enzyme may comprise 3 to 15% (w/w protein), for example 5 to 15% (w/w protein), including 5 to 12% (w/w protein), 5 to 10% (w/w protein) or 5 to 12% (w/w protein) within the substitute dairy food product.

Optionally the cellulase enzyme is totally denatured during production of the substitute food product.

The present invention thus further provides a substitute food composition comprising at least one cellulase enzyme and one or more of: lipids, proteins, sweetening agents, and/or ash, wherein said cellulase enzyme comprises at least 3% by weight of protein within the substitute food composition. Optionally, the content of the cellulase enzyme can be more than 3%, for example at least 10% w/w protein, for example at least 20% w/w protein.

Optionally, the cellulase enzyme is at least partially denatured in the substitute food product.

Optionally, the substitute food product is a substitute dairy product, such as a substitute cheese or yoghurt.

Optionally, the substitute food product is a substitute egg product.

Optionally the composition includes one or more of the following components: lipids, proteins, sweetening agents, colour balancing agent and/or ash. Optionally the composition includes a fat.

The composition used to form the substitute food product forms a further aspect of the present invention.

In one aspect the present invention provides an egg-like food product comprising a cellulase enzyme providing a minimum level of protein of 3% (w/w of protein), optionally with at least 5% (w/w protein), optionally with at least 10% (w/w protein), for example at least 20% (w/w protein). Optionally the enzyme can be the main protein constituent of the food product. The egg-like food product will have one or more properties selected from: foaming, emulsification, or binding properties, which are similar to that of whole eggs obtained from natural (avian) eggs. The egg-like food product can, for example, be used instead of avian eggs, for example can be fried directly to produce, a scrambled egg-type product or an omelette.

In one aspect the present invention provides an egg-white substitute with properties suitable for use in baked or cooked goods, the egg-white substitute comprising a cellulase enzyme, with the enzyme providing a minimum level of protein of 3% (w/w of protein), optionally with at least 5% (w/w protein), optionally with at least 10% (w/w protein), for example at least 20% (w/w protein). Optionally the cellulase enzyme can be the main protein constituent of the egg-white substitute. The egg white-like substitute will have one or more properties selected from: foaming, emulsification, or binding properties, which are similar to that of egg whites obtained from natural (avian) eggs. The egg-white substitute can, for example, be added to a dough instead of avian eggs and contribute to a foamy texture.

The egg replacement composition of the present invention may also be prepared as a spray-dried or desiccated composition and may be in the form of a powder that can be reconstituted with water and/or other liquids.

The egg replacement composition product and egg-based food product may have a natural egg-like texture, which is obtained by combining the protein with other modifiers, such as texture modifiers (such as a mucilage, e.g., a flaxseed extract or carbohydrate compounds, such as dextrose) and taste modifiers (for example yeast extract or salts). Salts added as taste modifiers may include conventional culinary salts such as sodium chloride and potassium chloride, but also salts such as kala namak, also known as Indian black salt, or Hawaiian black lava salt.

The egg white-like emulsion product may have a natural egg white-like texture, which is obtained by combining the protein with other modifiers, such as texture and taste modifiers, for example by the addition of a mucilage, e.g., flaxseed extract or flaxseed flour, carbohydrates (e.g., dextrose), yeast extract or salts. These salts may include conventional culinary salts such as sodium chloride and potassium chloride, but also salts such as kala namak, also known as Indian black salt, or Hawaiian black lava salt.

Another taste modifier can be yeast flocks. This results in a food product, specifically an egg replacer or egg white-like emulsion product, with a high versatility suitable for culinary applications in which eggs, and specifically egg whites, would typically find application.

The cellulase enzyme of the invention may be commercially produced, either by microbial fermentation, purified from non-animal or non-mammalian sources or produced by recombinant expression in a microbial host cell (typically a microorganism or plant cell).

Optionally, the cellulase enzyme may be commixed or admixed with one or more plant proteins to form the composition of the invention. Inclusion of one or more plant proteins can be desirable to improve the economics of manufacturing a substitute food product using a purified or recombinant protein, since a purified or recombinant protein is generally more expensive to produce than traditional food products.

### Substitute Dairy Products

In one embodiment of the invention there is provided a method for the production of a substitute dairy product, the method comprising the steps of:
providing at least one cellulase enzyme;
incorporating said at least one cellulase enzyme into a composition to form a substitute dairy product, for example a cheese, yoghurt or other dairy based product, and wherein said cellulase enzyme is subjected to one or more process steps to at least partially denature the cellulase enzyme during formation of the substitute dairy product.

Optionally, the cellulase enzyme comprises at least 3% by weight of protein in the substitute dairy product, for example at least 5% by weight, for example at least 7% (w/w protein) of the substitute dairy product or at least 10% (w/w protein) of the substitute dairy product.

Optionally, the cellulase enzyme is the main protein constituent of the substitute dairy product.

Optionally the cellulase enzyme is totally denatured.

The substitute dairy composition (intermediate to the substitute dairy product) may be a curd. The curd may be used to create further substitute dairy products. The substitute dairy product may be a substitute butter, cheese, yoghurt, custard, cream cheese, medium-hard cheese, hard cheese, pasta filata-type cheese, soft-ripened cheeses, feta-style cheese and the like.

When the substitute dairy product is in the form of a cheese or a yoghurt, the method may include a step of ripening the substitute dairy product. The substitute dairy product may thus be a ripened substitute dairy cheese or a ripened substitute dairy yoghurt.

For some cheese varieties, one or more bacteria or other microbial species can be employed in the cheese-making process for ripening or fermentation, where fermentative products and by-products such as lactic acid, carbon dioxide, alcohols, aldehydes and ketones are produced.

Optionally, the method of producing the substitute dairy product in accordance with the invention may include the step of adding one or more lipids, fats, or oils to form a substitute dairy composition including the cellulase enzyme.

Optionally, the method of producing the substitute dairy product in accordance with the invention may include the step of adding one or more of: carbohydrates, sweetening agents, and ash to form a substitute dairy composition including the cellulase enzyme.

The substitute dairy composition may include the cellulase enzyme in a concentration of about 0.01 g/L to about 1000 g/L inclusive, for example of from 10 g/L to 450 g/L, inclusive, more specifically of from 60 g/L and 350 g/L, inclusive.

The cellulase enzyme may be added in a purified form (for example at least 70%, 80%, 90%, 95%, 99%, or higher purity). Alternatively, the cellulase enzyme may be produced by microbial fermentation and may be provided in the form of a crude extract having a purity of 70% or less.

The substitute dairy product, such as a cheese or yogurt (joghurt) product, may include on or more different cellulase enzymes and/or hemicellulase enzymes.

The substitute dairy product of the invention may include one or more other proteins to form a substitute dairy composition including the cellulase enzyme. The one or more proteins to be included in the composition may include one or more non-dairy or dairy proteins. Soy protein or faba bean can be included, for example. Dairy proteins, may be included, typically as purified or recombinant dairy proteins. For the avoidance of doubt, a recombinant dairy protein is considered to be “animal free”. The dairy proteins may include one or more casein proteins. Alternatively, or additionally, the dairy proteins may include one or more whey proteins. Optionally, the casein and/or whey proteins can be recombinant proteins, for example can be produced by microbial fermentation. In some embodiments of these methods, the protein mixture can include one or more proteins selected from the group of: α-lactalbumin, β-lactoglobulin, α-S1-casein, α-S2-casein, lactoferrin, transferrin, and serum albumin.

The substitute dairy product or composition may include a total concentration of one or more lipids of about 0 weight % to about 45 weight %; a total concentration of one or more flavour compounds of about 0.01 weight % to about 6 weight %; a total concentration of about 0.1 weight % to about 6 weight % of one or more carbohydrates or sweetening agents; and a total concentration of ash of about 0.15 weight % to about 1.5 weight %, wherein the total of all ingredients sums to 100 weight %, with the balance being the cellulase enzyme and water. The lipids may be cultured lipids or microbially-produced lipids.

Optionally, the one or more lipids are selected from the group consisting of: sunflower oil, coconut oil, tributyrin, mono- and di-glycerides, free fatty acids, and phospholipids. Optionally, the substitute dairy product includes one of more of: a final concentration of sunflower oil of about 1 weight % to about 28 weight %; a final concentration of coconut oil of about 0.5 weight % to about 14 weight %; a final concentration of tributyrin of about 0.05 weight to about 1.0 weight %; a final total concentration of monoglycerides and diglycerides of about 0.08 weight % to about 1.2 weight %; a final total concentration of free fatty acids of about 0.02 weight % to about 0.28 weight %; and a final total concentration of phospholipids of about 0.02 weight % to about 0.3 weight percent.

Optionally, the free fatty acids comprise at least one fatty acid selected from the group of: butyric acid, caproic acid, caprylic acid, myristic acid and capric acid. In some embodiments of any of the compositions described herein, the phospholipids are soy lecithin phospholipids, sunflower lecithin phospholipids, cotton lecithin phospholipids, or rapeseed lecithin phospholipids. In some embodiments of any of the compositions described herein, the monoglycerides and diglycerides are plant-derived monoglycerides and diglycerides, or are bacteria-derived monoglycerides and diglycerides.

Optionally, the flavour compounds include at least one flavour compound selected from the group consisting of: δ-decalactone, ethyl butyrate, 2-furyl methyl ketone, 2,3-pentanedione, γ-undecalactone, and δ-undecalactone.

Optionally, the one or more sweetening agents is a saccharide. The saccharide can be selected from the group consisting of: glucose, mannose, maltose, fructose, galactose, lactose, sucrose, monatin, and tagatose. Alternatively, the one or more sweetening agents is an artificial sweetener. For example, the artificial sweetener can be selected from the group of: stevia, aspartame, cyclamate, saccharin, sucralose, mogrosides, brazzein, curculin, erythritol, glycyrrhizin, inulin, isomalt, lacititol, mabinlin, malititol, mannitol, miraculin, monatin, monelin, osladin, pentadin, sorbitol, thaumatin, xylitol, acesulfame potassium, advantame, alitame, aspartame-acesulfame, sodium cyclamate, dulcin, glucin, neohesperidin dihyrdochalcone, neotame, and P-4000.

Optionally, the ash includes one or more of: calcium, phosphorus, potassium, sodium, citrate, and chloride. In some embodiments of any of the compositions described herein, the ash comprises one or more (e.g., one, two, or three) of CaCl₂), KH₂PO₄, and Nas citrate. For example, the CaCl₂) can have a final concentration of about 0.05 g/L to about 0.2 g/L; the KH₂PO₄ can have a final concentration of about 0.2 g/L to about 0.4 g/L; and/or the Nas citrate can have a final concentration of about 0.1 g/L to about 0.3 g/L.

Optionally, the substitute dairy product includes one or more colour balancing agents, for example β-carotene or annatto.

### Substitute Egg Products

According to a further aspect of the invention there is provided a substitute-egg food product comprising:
at least one cellulase enzyme; wherein said at least one cellulase enzyme provides at least 3% (w/w) of the protein content of the product (optionally is the main protein constituent of the substitute-egg food product).

In an alternative aspect, there is provided a method for the production of a substitute egg food product, the method comprising the steps of:
providing at least one cellulase enzyme;
subjecting the at least one cellulase enzyme to one or more process steps to at least partially denature the cellulase enzyme; and
incorporating said at least partially denatured cellulase enzyme into a composition to form a substitute egg food product.

The substitute-egg food product can be an egg replacement composition (egg replacer), an egg-like food product or an egg-white substitute.

Optionally, the cellulase enzyme is partially or totally denatured. Alternatively, the cellulase enzyme is denatured during cooking of the food product itself or a food composition incorporating the food product (for example where an egg replacement composition or egg-white substitute is added to other ingredient to form a food product).

Optionally, the substitute-egg food product includes one or more lipids. Optionally, the substitute-egg food product further comprises water, carbohydrate (such as dextrose, flaxseed powder or extract), a fat (such as coconut fat), and a salt, and optionally may also comprise a colorant (e.g., β-carotene). The substitute-egg food product can be produced by hydration of the cellulase enzyme and carbohydrate in water followed by homogenization to incorporate the fat and any colorant. The emulsion can then be pasteurized. If the product is to be used in liquid form, the pasteurized liquid can be filled into bottles and can then be used for the different applications. Alternatively, the liquid can be formed into a powder, for example by freeze-drying.

Optionally the substitute-egg food product includes one or more additional proteins (preferably non-egg proteins, more preferably plant proteins). A small amount of additional proteins can be provided by a seed mucilage, for example a flaxseed mucilage. However, a seed mucilage will mainly comprise carbohydrate. Optionally the substitute-egg food product includes one or more carbohydrates. Optionally the substitute-egg food product includes one or more sweetening agents. Optionally the substitute-egg food product includes one or more colouring agents. Optionally the substitute-egg food product includes one or more vitamins, such as a yeast extract. Optionally the substitute-egg food product includes one or more minerals or salts.

Optionally, the cellulase enzyme is denatured by a heat treatment, for example by heating to a temperature of 40° C. to 100° C. for a suitable period of time, for example from 10 to 90 minutes. The cellulase enzyme can be denatured during cooking of the final food composition to provide a cooked foodstuff.

The cellulase enzyme may be an isolated (purified) enzyme.

The cellulase enzymes may be commercially produced enzymes, optionally produced either by recombinant (for example recombinant microbial) processes or purified from non-animal sources.

Optionally, the cellulase enzyme used within the product of the present invention is recombinantly produced, that is a gene encoding the protein sequence of the enzyme(s) are expressed under controlled conditions. Any suitable host cell can be used, for example a micro-organism such as a yeast or bacteria. Optionally the gene encoding the enzyme is expressed using a heterologous host cell. Alternatively, the gene encoding the cellulase enzyme can be expressed within a homologous host cell, which can optionally be engineered to exhibit above-normal levels of expression, for example by manipulation of the native promoter and/or enhancer sequences.

The cellulase enzymes used in the present invention can be neutrally flavoured and can be manipulated to form gels, emulsions, or egg replacers with a texture and mouthfeel that can be optimised through modification of process conditions known to those skilled in the field of the invention. Many of these cellulase enzymes are commercially available in the marketplace: the availability of these enzymes presents an opportunity for ameliorating the costly economics involved in making substitute food product from recombinantly produced food proteins.

Optionally, the cellulase enzyme can then be combined with other ingredients to form the substitute-egg food product. Thus, the invention provides a method of producing a substitute-egg food product, which method comprises providing an cellulase enzyme and adding one or more lipids, proteins, carbohydrates, sweetening agents, colouring agents, vitamins, minerals and/or salts to the cellulase enzyme to form a substitute-egg food product. Optionally the cellulase enzyme comprises at least 3% of the protein content of the substitute egg food product (optionally with at least 5% w/w protein, for example at least 10% w/w protein, for example at least 20% w/w protein). Optionally the cellulase enzyme can be the main protein constituent of the food product.

Where the substitute-egg food product is an egg replacement composition, this composition can then be formed into an egg-based food product, such as a pancake, baked goods (biscuits, cakes, breads and the like), or mixtures therefore.

The invention is based on the realisation that cellulase enzymes, when denatured or hydrolysed (partially or fully) can be used to produce egg-based food product compositions that exhibit a similar taste, aroma, and mouth feel as such products made using eggs (“traditional eggs” or “traditional egg-based food products”, the latter being products which would normally include eggs as an ingredient, typically as a binder, for example baked products, pancakes, deserts). The present invention therefore provides compositions, methods of making the compositions, and kits including cellulase enzyme, compositions, emulsions, and mixtures useful for making these egg-based food product compositions.

The substitute-egg food products, (egg replacement compositions, egg-like food products and egg-white substitutes) provided herein have a similar taste, mouth feel, aroma, and nutritional value as compared to equivalent products made using an avian egg.

The substitute-egg food products may include the at least one cellulase enzyme in a concentration of about 30 to 98 g enzyme/100 g (total protein content), typically of from 55 to 98 g enzyme/100 g (total protein content), more specifically of from 70 to 98 g enzyme/100 g (total protein content).

The cellulase enzyme used may be in a purified form containing at least 40% by weight protein (enzyme) per enzyme composition (for example at least 50%, at least 60%, at least 70%, at least 80%, at least 90%, at least 95%, at least 99%, or higher purity). This reflects the content of commercially available enzyme compositions, which can include fillers such as maltodextrin. Alternatively, the cellulase enzyme may be produced by microbial fermentation and may be provided in the form of a crude extract having a protein content of 70% or less (w/w). These percentages are by reference to the total content of the enzyme composition.

The substitute-egg food product of the invention may include one or more other additional proteins to produce a protein mixture. The one or more additional proteins to be included in the protein mixture may include one or more enzymes or food proteins. The term “food proteins” means any non-animal derived protein which can be added to food. Optionally, the additional proteins can be purified or recombinant proteins obtained from non-animal sources. The additional proteins may include one or more avian egg proteins, but could also include other enzymes. Alternatively, or additionally, the additional proteins may include one or more recombinant dairy proteins, such as casein or whey proteins, optionally produced by microbial fermentation. Optionally, the protein mixture can include one or more additional proteins selected from the group of: α-lactalbumin, β-lactoglobulin, α-S1-casein, α-S2-casein, lactoferrin, transferrin, and serum albumin.

Optionally, the substitute-egg food product (for example the egg replacement composition) can comprise one or more lipids. The lipids can be in the form of oils or fats. The lipids may be selected from the group consisting of: sunflower oil, coconut oil, rapeseed oil, palm fat, tributyrin, mono- and di-glycerides, free fatty acids, and phospholipids. The lipids may be cultured oils or fats, or microbially-produced or microbially-derived oils or fats. Optionally, the substitute-egg food product (for example the egg replacement composition) can comprise a carbohydrate. The carbohydrate may be obtained from a plant. The carbohydrate may be a monosaccharide, a disaccharide, a polysaccharide or a mixture thereof. The carbohydrate may be a starch, a gum, an edible fibre, a flour, or a mixture thereof. When the carbohydrate is in the form of a starch, the starch may be selected from the group consisting of tapioca starch, corn starch, potato starch, wheat starch, waxy maize starch, modified starch and mixtures thereof. Starch may comprise of from 0.1% and 50% by mass of the egg replacer. When the carbohydrate is in the form of a gum, the gum may be selected from the group consisting of arrowroot flour, xanthan gum, tara gum, guar gum, agar gum, locust bean gum, and gum arabic, and mixtures thereof. Gum may comprise between 0.1% and 50% by mass of the egg replacer. The carbohydrate may be in the form of exopolysaccharides, typically originated from microbial cultures, such as dextran, fructan, galactan, xanthan and their derivatives with a molecular weight of 1 to 10,000 kDa.

In one embodiment of the invention, the substitute-egg food product (for example the egg replacement composition) can comprise a mucilage containing plant seeds, or its flour, its fractionated flour, or its extracted mucilage to which the cellulase enzyme is added. Optionally, the mucilage may be a flaxseed mucilage or aloe vera extract. Optionally, flaxseed flour or fractionated flour can be used. Optionally, the mucilage is based on chia seeds, psyllium husk, aqua faba extract, chickpea water, hemp seeds, wheat germ, and the like. Instead of flaxseed mucilage, fibers, such as flaxseed fiber, hydrocolloids, modified starches or soluble fibres such as β-glucan, xanthan gum, pectin and the like can be used.

Optionally β-carotene is added to the substitute-egg food product (for example the egg replacement composition) as a natural colorant. However, other yellow, orange, red colourants, natural extracts, or artificial colourants may be used e.g., turmeric, pepper extract, capsicum annum L, tomato extract, lycopene, carrot extract, annatto, safflower and the like. Optionally, one or more flavour compounds may be added to the substitute-egg food product (for example the egg replacement composition). The flavour can be selected from the group consisting of: fully or partially degraded beta-lactoglobulin, extracts containing fully or partially degraded beta-lactoglobulin (specifically biomass extracts containing such compounds created using precision fermentation), δ-decalactone, ethyl butyrate, 2-furyl methyl ketone, 2,3-pentanedione, γ-undecalactone, and δ-undecalactone, sulphur containing flavour compounds (e.g. 2-acetyl thiazoline, dimethyl sulphide, allyl isothiocyanate, diallyl thiosulfinate, diallyl disulphide, and the like), hydrogen sulphide. The flavour compounds may be natural or artificial. Optionally, one or more sweetening agents may be added to the substitute-egg food product (for example the egg replacement composition). The one or more sweetening agents may be a saccharide(s). Optionally, the saccharide is selected from the group consisting of: glucose, mannose, maltose, fructose, galactose, lactose, sucrose, monatin, and tagatose. The sweetening agent may also have a neutral taste, such as a maltodextrin. Optionally, the one or more sweetening agents may be an artificial sweetener. Optionally, one or more salts may be included in the substitute-egg food product (for example the egg replacement composition). Exemplary salts include one or more of: calcium, phosphorus, potassium, sodium, citrate, and chloride salts.

Optionally, the egg replacement composition has a pH of about 4.6 to 8.0, for example about 6.2 to about 7.2 (e.g., about 6.2 to about 6.8).

The egg replacement composition or egg-white substitute of the invention may be used in baking or cooking, as binding agent, such as a replacer for eggs in frozen desserts, bakery mixes, meringues, coatings, batters, cakes, pancakes, tarts, confections, panade for use in, for example, croquettes, in alcoholic beverages such as whisky sour, pisco sour, and the like. The invention extends to a baked or cooked product (i.e., an “egg-based food product”) produced using the egg replacer or egg-white substitute of the invention.

The term “egg replacement composition” (or “egg replacer”) means a product which resembles a composition formed using an avian egg as its main component, for example a beaten egg. Thus, the term “egg replacement composition” as used herein means a product resembling a traditional egg product, but made with proteins produced by processes not involving mammals. For example, the proteins used can be plant-based proteins or, more preferably, are recombinantly expressed proteins, for example are proteins which are expressed using microbial host cells. Optionally, the “egg replacement composition” of the invention is similar to, equivalent to, or is nearly identical to the corresponding product formed using an avian egg especially as regards one or more of taste, aroma, flavour, mouthfeel, organoleptic qualities, colour, and the like. Optionally, the “egg replacement composition” of the invention is made with proteins produced by processes not involving animals.

The “egg replacement composition” of the present invention refers to a composition which comprises an at least partially denatured cellulase enzyme in addition to other ingredients. The egg replacement composition is an intermediate composition for addition to an egg-based food product or composition.

The term “egg-white substitute” (or “egg-white replacer”) means a product which resembles a composition formed using the white (non-yolk) or an avian egg without any other components. Thus, the term “egg-white substitute” as used herein means a product resembling an avian egg-white, but made with proteins produced by processes not involving mammals. For example, the proteins used can be plant-based proteins or, more preferably, are recombinantly expressed proteins, for example are proteins which are expressed using microbial host cells. Optionally, the “egg-white substitute” of the invention is similar to, equivalent to, or is nearly identical to the corresponding product formed using an avian egg white especially as regards one or more of taste, aroma, flavour, mouthfeel, organoleptic qualities, colour, and the like. Optionally, the “egg-white substitute” of the invention is made with proteins produced by processes not involving animals.

The term “egg-based food product” refers to a food product which is in a form suitable for eating or for sale to consumers and which has been made using the egg replacement composition or the egg-white substitute of the invention. Optionally, these products can be referenced as “synthetic food products”. Optionally, these goods can be cooked or baked at home by the consumer or can be in kit form, for example a cake mix which requires other ingredients to be added (for example fat, milk or water). The term “egg-based food product composition” refers to a composition for production of a food product which composition includes the egg replacement composition or the egg-white substitute of the invention. The composition can include all ingredients for the end food product, which can optionally be in a “ready-to-cook” or part-baked format or may be in the form of a kit to which other ingredients are intended to be added to form the final food product.

The term “avian egg” refers to an egg which has been laid by a bird such as chicken, duck, quail or the like.

### Egg Replacement Composition (Egg Replacer)

Optionally, the cellulase enzyme may be commixed or admixed with one or more plant products, such as plant proteins or fats, to form the egg replacement composition of the invention. Inclusion of more or more plant products can be desirable to improve the economics of making an egg-replacement composition and any food product containing the same from a purified or recombinant protein, since a recombinant protein is generally more expensive to produce than traditional food products.

The egg replacement composition may include a final total concentration of one or more lipids of about 0 weight % to about 30 weight %; a final total concentration of one or more flavour compounds of about 0.01 weight % to about 4 weight %; a final total concentration of about 0.1 weight % to about 60 weight % of one or more carbohydrates or sweetening agents; and a final total concentration of salts of about 0.15 weight % to about 1.5 weight %.

Optionally, the egg replacement composition may contain one or more lipids, in the form of oils or fats. Optionally, the lipids may be selected from the group consisting of: sunflower oil, coconut oil, rapeseed oil, palm fat, tributyrin, mono- and di-glycerides, free fatty acids, and phospholipids. Additionally, or alternatively, the lipids may be cultured lipids or microbially-produced lipids. Such lipids, including phospholipids, may be produced by precision fermentation techniques. Optionally, lipid is a free fatty acid selected from the group of: butyric acid, caproic acid, caprylic acid, and capric acid. Optionally, the lipid is a phospholipid, such as soy lecithin phospholipids, sunflower lecithin phospholipids, cotton lecithin phospholipids, or rapeseed lecithin phospholipids. Optionally, the lipid can be monoglycerides and diglycerides which are plant-derived monoglycerides and diglycerides, or are bacteria-derived monoglycerides and diglycerides.

As noted above, the egg replacement composition may comprise a carbohydrate. The carbohydrate may be obtained from a plant. The carbohydrate may be a monosaccharide, a disaccharide, a polysaccharide or a mixture thereof. The carbohydrate may be a starch, a gum, an exopolysaccharide, an edible fibre, a flour, or a mixture thereof. When in the form of a starch, the starch may be selected from the group consisting of tapioca starch, corn starch, potato starch, wheat starch, waxy maize starch, modified starch and mixtures thereof. The starch may comprise from 0.1% to 50% by mass of the egg replacer. When the carbohydrate is in the form of a gum or exopolysaccharide, the gum may be selected from the group consisting of arrowroot flour, tara gum, guar gum, agar gum, locust bean gum, and gum arabic, and mixtures thereof. Exopolysaccharides may be selected from the group consisting of dextran, fructan, galactan, xanthan, and mixtures thereof. The gum may comprise from 0.1% to 50% by mass of the egg replacer.

Optionally, one or more sweetening agents may be added to the egg replacement composition. The one or more sweetening agents may be a saccharide. Optionally, the saccharide is selected from the group consisting of: glucose, mannose, maltose, fructose, galactose, lactose, sucrose, monatin, and tagatose. The sweetening agent may also have a neutral taste, such as a maltodextrin. Optionally, the one or more sweetening agents is an artificial sweetener. Optionally, the artificial sweetener is selected from the group of: stevia, aspartame, cyclamate, saccharin, sucralose, mogrosides, brazzein, curculin, erythritol, glycyrrhizin, inulin, isomalt, lactitol, mabinlin, maltitol, mannitol, miraculin, monatin, monelin, osladin, pentadin, sorbitol, thaumatin, xylitol, acesulfame potassium, advantame, alitame, aspartame-acesulfame, sodium cyclamate, dulcin, glucin, neohesperidin dihyrdochalcone, neotame, and P-4000. Optionally, the composition will include one or more colourants, such as β-carotene.

As noted above, the egg replacement composition can include one or more salts. Optionally, the egg replacement composition can include one or more salts selected from: calcium, phosphorus, potassium, sodium, citrate, and chloride salts. Optionally, the salts used include one or more (e.g., one, two, or three) of CaCl₂, KH₂PO₄, and Na₃ citrate, K₂CO₃, Mg₃ (C₆H₅O₇)₂. Optionally, the egg replacer includes CaCl₂ at a final concentration of about 0.05 g/L to about 0.2 g/L; and/or KH₂PO₄ at a final concentration of about 0.2 g/L to about 0.4 g/L; and/or Nas citrate at a final concentration of about 0.1 g/L to about 0.3 g/L; and/or K₂CO₃ at a final concentration of about 0.1 g/L to about 0.5 g/L; and/or Mg₃(C₆H₅O₇)₂ at a final concentration of about 0.01 g/L to about 0.3 g/L.

Optionally, depending on the required end use of the egg replacement composition, one or more bacteria or other microbial species is employed in the process of forming the egg replacement composition for ripening or fermentation where fermentative products and by-products such as lactic acid, carbon dioxide, alcohols, aldehydes and ketones are produced.

The cellulase enzyme(s) used in the present invention may be commercially produced enzymes, produced either by recombinant microbial processes, or purified from non-animal or non-mammalian sources.

In one embodiment the egg replacer combines cellulase enzyme with potato protein, flaxseed fiber, sunflower oil, sunflower lecithin, salt, colorant and water.

### Egg-White Substitute

The egg-white substitute is made as described above for the egg replacement composition, but will typically not include a colourant such as β-carotene. An example composition would include the cellulase enzyme, water, flaxseed mucilage or flaxseed fibre, and fat (such as coconut oil or sunflower oil, for example).

The egg replacement composition and/or egg-white substitute can each be combined with other food ingredient to form a foodstuff which would typically comprise avian eggs.

### Egg-Like Food Product

The egg-like food product is made as described above for the egg replacement composition, and will typically include a colourant such as β-carotene. An example composition would include the cellulase enzyme, water, flaxseed mucilage or flaxseed fibre, fat (such as coconut oil or sunflower oil, for example), a colourant such as β-carotene and optionally a dextrose.

In a further aspect, the present invention provides a process of forming a substitute egg product, wherein an cellulase enzyme is mixed with water to form a mixture and said mixture is homogenised with a fat, wherein said cellulase enzyme provides at least 5 g/100 g protein of the product. Optionally, the cellulase enzyme is mixed with a carbohydrate source together with the water, for example a seed mucilage or a flour. One suitable seed mucilage is a flax seed mucilage. Optionally a fat can be added to the mixture and homogenized to form the substitute egg product. Suitable fats are described above and include, for example vegetable oils, sunflower oils, coconut fat. Optionally other flavourings, sweetening agents, ash, salts and/or colorants can be added, as described above with regard to the composition. These additional components can be added before or after homogenisation, as convenient.

The present invention may be further defined by reference to the following clauses:
1. According to one aspect of the invention there is provided a method for the production of a substitute dairy product, the method comprising the steps of: providing an enzyme having a catalytic function;
   subjecting the enzyme to one or more treatment steps to convert said enzyme into a converted protein having a structural function; and incorporating said converted protein into a substitute dairy product.
2. The method of clause 1, wherein the enzyme is treated to render it substantially devoid of its catalytic function.
3. The method of clause 1 or clause 2, wherein the at least one enzyme is a globular enzyme.
4. The method of any one of clause 1 to 3, wherein the enzyme is selected from the group consisting of: a lactase, a glucosidase, a cellulase, an amylase, an invertase, a protease, xylanase, glutenase, phytase, lipase, gelatinise, glucose oxidase, transglutaminase, pectinase, beta amylase, pullulanase, naringinase, limoninase, aminopeptidase, laccase, tyrosinase, cutinase, superoxide dismutase, endoglycosidase, glycocyl transferase, glucose isomerase, amidase, lignin peroxidase, invertase, and a kinase.
5. The method of clause 4, wherein the enzyme is selected from the group consisting of: beta-galactosidase, alpha glucosidase, a cellulase, alpha amylase, nattokinase, glucoamylase, and invertase.
6. The method of any one of clauses 1 to 5, wherein a curd or emulsified composition from such globular enzymes is obtained, such curd or emulsified composition being suitable for production of an animal-free product resembling one or more desired properties of a dairy product.
7. The method of any one of clauses 1 to 6, wherein the enzyme is treated by way of hydrolysis (pH-based hydrolysis or enzymatic hydrolysis), heat-treatment, or mechanical shearing to at least partially, or fully, denature the enzyme, rendering a structural protein component or structural protein constituent.
8. The method of any one of clauses 1 to 5, wherein the enzyme is heat-treated to between 4° and 100° C.
9. The method of clause 8, wherein the heat treatment is performed for a period of between 1 min and 500 min, typically between 5 min and 90 min, most typically between 10 to 30 minutes
10. A non-milk protein component having a desirable attribute.
11. The non-milk protein component of clause 10, which is a non-dairy protein treated to convert it into a protein having a structural function suitable for use in the production of a substitute dairy product, such as, for example, a substitute cheese product.
12. A substitute dairy product produced by treating at least one enzyme with a catalytic function to render such enzyme suitable for structural purposes in a substitute dairy product.
13. The substitute dairy product of clause 12, which is a substitute curd, substitute milk, butter, cheese, yoghurt, custard, cream cheese, medium-hard cheese, hard cheese, pasta filata-type cheese, soft-ripened cheeses and other substitute dairy products.
14. The substitute dairy product of clause 13 which, when in the form of a substitute cheese product or substitute yoghurt product, is a ripened substitute cheese product or ripened substitute yoghurt product.
15. The substitute dairy product of any one of clauses 12 to 14, wherein the protein treated in accordance with the method of the invention is present in a concentration of about 0.01 g/L to about 1000 g/L inclusive, typically between 10 g/L to 450 g/L, inclusive, more specifically between 60 g/L and 350 g/L, inclusive.

The present invention may be further defined by reference to the following clauses:
1A. A method for the production of an egg replacer, the method comprising the steps of:
   providing an enzyme having a catalytic function;
   subjecting the enzyme to one or more treatment steps to convert said enzyme into a converted protein having a structural function; and
   incorporating said converted protein into an egg replacer.
2A. The method of clause 1, wherein the enzyme is at least partially denatured to render it substantially devoid of its catalytic function.
3A. The method of clause 1 or clause 2, wherein the at least one enzyme is an isolated enzyme, specifically a globular enzyme.
4A. The method of any one of clauses 1 to 3, wherein the enzyme is selected from the group consisting of: a lactase, a glucosidase, a cellulase, an amylase, an invertase, a protease, xylanase, glutenase, phytase, lipase, gelatinise, glucose oxidase, transglutaminase, pectinase, beta amylase, pullulanase, naringinase, limoninase, aminopeptidase, laccase, tyrosinase, cutinase, superoxide dismutase, endoglycosidase, glycocyl transferase, glucose isomerase, amidase, lignin peroxidase, invertase, and a kinase.
5A. The method of clause 4, wherein the enzyme is selected from the group consisting of: beta-galactosidase, alpha glucosidase, a cellulase, alpha amylase, nattokinase, glucoamylase, and invertase.
6A. The method of any one of clauses 1 to 5, wherein an egg white-like emulsified composition from such globular enzymes is obtained, such egg white-like emulsified composition being suitable for production of an animal-free food product including one or more desired properties of a food product.
7A. The method of any one of clauses 1 to 6, wherein the enzyme is treated by way of hydrolysis (pH-based hydrolysis or enzymatic hydrolysis), heat-treatment, or mechanical shearing to at least partially, or fully, denature the enzyme, rendering a structural protein component or structural protein constituent.
8A. The method of any one of clauses 1 to 5, wherein the enzyme is heat-treated to between 4° and 100° C.
9A. The method of clause 8, wherein the heat treatment is performed for a period of between 1 min and 500 min, typically between 5 min and 90 min, most typically between 10 to 30 minutes
10A. An enzyme treated to convert it into a protein having a structural function suitable for use in the production of a substitute food product, such as, for example, an egg replacer.
11A. A substitute food product produced by treating at least one enzyme with a catalytic function to render such enzyme suitable for structural purposes in a substitute food product.
12A. The substitute food product of clause 11, wherein the protein treated in accordance with the method of the invention is present in a concentration of about 0.01 g/L to about 1000 g/L inclusive, typically between 10 g/L to 450 g/L, inclusive, more specifically between 60 g/L and 350 g/L, inclusive.
13A. An egg replacer comprising a non-egg protein as the main structural protein.
14A. The egg replacer of clause 13, wherein the non-egg protein comprises an at least partially denatured isolated enzyme.
15A. The egg replacer of clause 14, wherein the enzyme is a deactivated isolated enzyme or fully denatured isolated enzyme.
16A. An egg white-like emulsion product comprising a non-egg protein as the main protein source.
17A. The egg white-like emulsion product of clause 16, wherein the non-egg protein is an at least partially denatured isolated enzyme.
18A. The egg white-like emulsion product of clause 16 or clause 17, wherein the non-egg protein component is a deactivated isolated enzyme, or fully denatured isolated enzyme

Further features of the invention will become apparent from the following description, by way of example only, with reference to the accompanying figures and examples.

### EXAMPLES

### Example 1—Functionality/Gelation of Cellulase Enzyme/Beta-Glucanases

Tab water was mixed with an enzyme product to obtain a solution containing 10% (w/w) protein. Enzyme ingredient tested:
A) Cellulase/beta-glucanase [Trichoderma reesei], powder, 53% protein (w/w, measured by Dumas method), Rajvi Bioteck Pvt. Ltd
B) Cellulase/beta-glucanase [Trichoderma reesei], powder, 50% protein (w/w, measured by Dumas method), Bioven Ingredients

Each solution was split in 3 tubes and pH was adjusted by Lactic acid 80% (w/w) or 1 M NaOH (w/w) to pH 6.5, 5.5 and 5.0 respectively. Each of the samples was split in 2 microtubes, and in one of those 1% (w/w) NaCl was added.

### Process Steps:

samples were mixed
samples were centrifuged (10 seconds, 13300 rpm)
incubation at room temperature for 30 min
heat treatment (80° C., 30 min)
cooling down in cold water
sample removal from microtubes for visual analysis

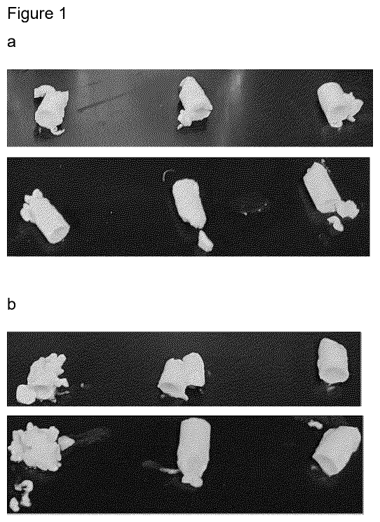

Observation: All samples containing 10% (w/w) protein formed strong off-white curds/gels after incubation at 80° C.—see FIGS. 1 a and b. Gel strength increased with pH increase.

### Example 2—Gelation of Cellulase and Hemicellulase Enzymes

Three different enzyme products were tested for their gelation properties.

### Ingredients:

Names of the enzyme preparations and their suppliers:

| | | | Total |
|---|---|---|---|
| | | | protein |
| | | | content |
| Enzyme | Product Name | Supplier | (w/w) |
| Cellulase | Cellulase | Advanced | 21.21% |
| enzyme | enzyme | Enzyme Technologies | |
| | Complex | Ltd | |
| Hemicellulase | Hemicellulase | Advanced | 25.05% |
| enzyme | enzyme | Enzyme Technologies | |
| | | Ltd | |
| Cellulase | Bakemyl ® WXE | Breatec B.V. | 62.10% |
| enzyme | Conc | | |

### Formulations:

| | Formulation | | | | | | | | |
|---|---|---|---|---|---|---|---|---|---|
| | Stock 1 | | | Stock 2 | | | Stock 3 | | |
| | Product Name | | | | | | | | |
| | Cellulase enzyme Complex | | | Hemicellulase enzyme | | | Bakemyl ® WXE Conc | | |
| | Ingred. | Mass | | Ingred. | Mass | | Ingred. | Mass | |
| Material | % | g | Protein | % | g | Protein | % | g | Protein |
| Protein | 25.93 | 6.48 | 5.50% | 21.96 | 5.49 | 5.50% | 8.86 | 2.21 | 5.50% |
| Ingred. | | | | | | | | | |
| Distilled | 74.-07 | 18.52 | | 78.04 | 19.51 | | 91.14 | 22.79 | |
| Water | | | | | | | | | |
| | 100% | 25.00 | | 100% | 25.00 | | 100% | 25.00 | |
| | Initial pH | 4.4 | | | 4.88 | | | 4.609 | |

For pH adjustment, solutions of 1M HCl or 1M NaOH were used. For salt adjustment, a 25% w/w/NaCl solution was used.

### Process Steps:

Dissolve enzyme products in water (stirring plate, room temperature, 30 minutes)
Solutions of each enzyme product were filled in 8 different tubes. The pH in the tubes was adjusted to 6.0, 5.5, 5.0 or 4.0 (two tubes with each pH value) using 1M HCl or 1M NaOH.
Add 25% w/w NaCl solution to one of the tubes per pH value to yield a concentration of 0.75% w/w.
   Heat treatment of all samples (Thermoblock, 85° C., 30 minutes).—Stop gelation by placing the tubes in cold water.

For analysis, the content was removed from the tubes for investigation,

### Results and Discussion:

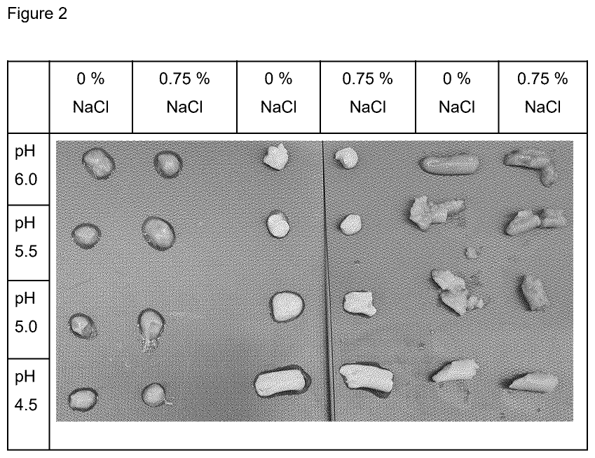

All samples formed gels. The strongest gels were formed by the BakemyI® WXE Conc cellulase enzyme samples. The sample forming the strongest gels was made from the ingredient with the highest total protein content (see FIG. 2).

### Example 3—Substitute Cheese Product

### Ingredients:

| | | Cellulase enzyme Bakemyl | |
|---|---|---|---|
| | | WXE Conc | |
| INGREDIENTS | | Total protein content 62.10% | |
| Supplier | Name | g | % |
| | Tap Water | 100.7 | 67 |
| Vandemoortele/L0404 | Coconut fat | 18.0 | 12.0 |
| | Lactase | 30.0 | 20.0 |
| Rewe/LXX20294801 | Salt (NaCl) | 0.8 | 0.50 |

| | | | |
|---|---|---|---|
| AZELIS/B. E489R | Nutriose FM10 | 0.0 | 0.0 |
| Ja (Rewe)/L116008000 | Sugar | 0.5 | 0.3 |
| Citrique Belge | Citric Acid 25% | 0.0 | 0.0 |
| C. Hansen + Danisco | Cultures | 0.06 | 0.038 |

| | |
|---|---|
| Total weight (g) | 150.0 |

### Process Steps:

Dissolve enzyme products in water with all other ingredients except coconut fat (stirring plate, 40° C., 1 hour).
   Add melted coconut fat (stirring plate, 40° C., 2 minutes).
   Emulsion (Homogeniser Panda, 40° C.).
   Adjust pH to 5.7 with 1M NaOH.
   Heat treatment of all samples (Thermoblock, 90° C., 20 minutes).—Stop gelation by placing the tubes in ice bath (10 minutes).

### Results and Discussion:

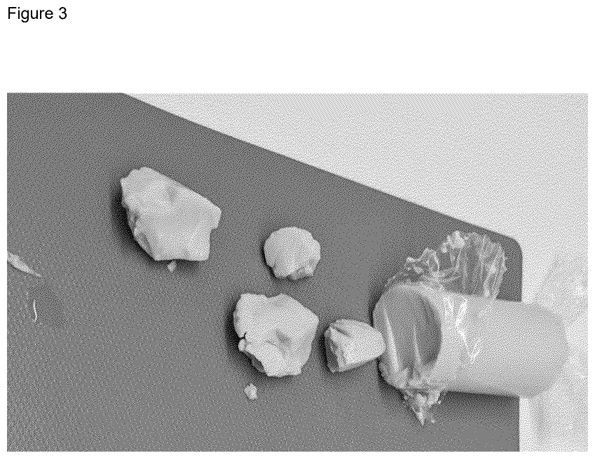

The formulation yielded a soft, homogenous and slightly yellow/brown gel with a soft mouthfeel and relatively neutral taste. The substitute dairy product is shown in FIG. 3.

### Example 4—Yoghurt Substitute

Hydrated Cellulase enzyme paste converted into a substitute yoghurt.

Details of the enzyme used: supplier Breatec, Cellulase enzyme [Trichoderma reesei], Bakemyl WXE Conc containing a protein content of 62%. (referred to “Cellulase enzyme A”)

### Ingredients:

| | | % |
|---|---|---|
| | Tap Water | 71.8 |
| Protein | Cellulase | 9 |
| | enzyme | |
| Fibre | flaxseed fibre | 0.5 |
| Salt | Salt | 0.7 |
| Fat | Coconut fat | 18 |

### Protocol

If required, grind using mortar and pestle or other appropriate method
Hydrate dry ingredients (Cellulase enzyme A, Salt, Nutriose, flaxseed fibre) for 30 min and add the fat
Homogenise the mix
Adjust pH to 4.5
Heat to 75° C. for 20 minutes in a waterbath
smoothening
Let the curd cool down and store the curd under refrigerated conditions for 12-48 h until analysis

### Results and Discussion:

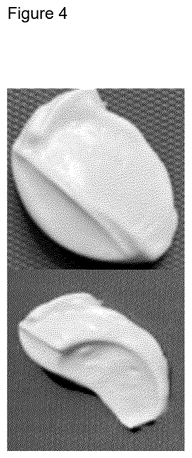

Visual examination—Yoghurt substitute based on Cellulase enzyme A. The substitute dairy product is shown in FIG. 4.

### Rheological Measurement:

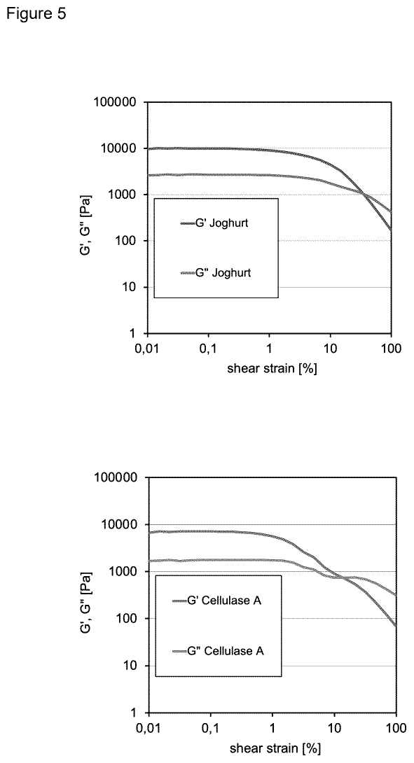

Amplitude-sweeps of cow-milk based Joghurt and substitute joghurt made of Cellulase enzyme A—see FIG. 5. The cow-milk based yoghurt contained fat: 3.5 g, carbohydrates: 4.6 g, protein 3.7 g and salt: 0.12 g and was produced for Netto by Marken Discount AG & Co Kg.

The amplitude sweeps aim at describing the deformation behavior of samples in the non-destructive deformation range and at determining the upper limit of this range. The measuring results of amplitude sweeps are usually presented as a diagram with strain (or shear stress) plotted on the x-axis and storage modulus G′ and loss modulus G″ plotted on the y-axis; both axes on a logarithmic scale. Our amplitude sweep results showed that the height and the course of the storage modulus of the Cellulase enzyme A sample is very similar to the Joghurt sample.

### Example 6—Substitute Cheese Product—Fresh Cheese

Hydrated cellulase enzyme paste can be converted into a substitute cheese.

### Ingredients:

Details of the enzyme used: supplier Breatec, Cellulase enzyme [Trichoderma reesei], Bakemyl WXE Conc containing a protein content of 62%. (referred to “Cellulase enzyme A”)

Details of the enzyme used: supplier Novozymes, Cellulase enzyme [Trichoderma reesei], Novozymes Celluclast Conc. BG containing a protein content of 54.7%. (referred to “Cellulase enzyme B”)

### Ingredients

| | | % |
|---|---|---|
| | Tap Water | 69.3 |
| Protein | Cellulase | 12 |
| | enzyme | |
| Salt | Salt | 0.7 |
| Fat | Coconut | 18 |
| | fat | |

### Protocol Fresh Cheese

If required, grind using mortar and pestle or other appropriate method
Hydrate dry ingredients (Cellulase enzyme A or B, Salt) for 30 min and add the fat
Homogenise the mix
Adjust pH to 4.5
Heat to 80° C. for 20 minutes in a waterbath
Pressing (3 bar, 10 min)
Let the curd cool down and store the curd under refrigerated conditions for 12-48 h until analysis

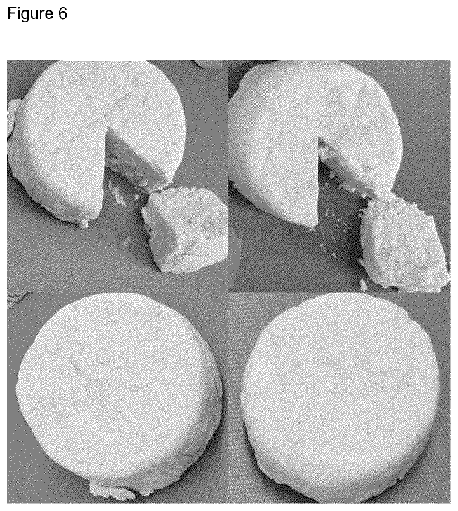

Results and discussion: The substitute dairy product is shown in FIG. 6. Fresh cheeses made of Cellulase enzyme A (left) and Cellulase enzyme B (right)

### Rheological Measurement:

Amplitudes weeps of commercial Almette fresh cheese and fresh cheese made of Ceallulase A and B. The cow milk based fresh cheese Almette contained (in 100 g) 25 g fat, 3 g carbohydrates, 5.6 g protein and 0.68 g salt. It was produced by Hochland Deutschland GmbH. Ingredient list: fresh cheese, salt and nitrogen.

Our amplitude sweep data showed that the height and the course of the storage modulus of Cellulase enzyme A and B fresh cheeses is very similar to the Almette fresh cheese sample.

### Example 7—Egg Substitute

Hydrated Cellulase enzyme paste converted into a substitute egg.

Details of the enzyme used: supplier Breatec, Cellulase enzyme [Trichoderma reesei], Bakemyl WXE Conc containing a protein content of 62%. (referred to “Cellulase enzyme”)

### Protocol

If required, grind using mortar and pestle or other appropriate method
Hydrate dry ingredients (Cellulase enzyme, Salt, Nutriose, flaxseed fibre, β-carotene, flavour) for 30 min and adjust pH to 6.3
Add the oil/lecithin mix
Homogenise the mix
Frying in the pan

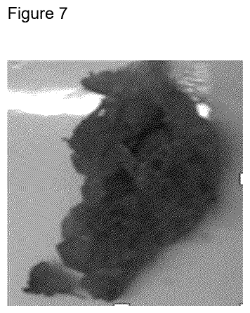

Results: The substitute egg product is shown in FIG. 7.

1. A method for the production of a substitute food product, the method comprising the steps of.
i. providing at least one cellulase enzyme;
ii. subjecting the at least one cellulase enzyme to one or more process steps to at least partially denature the cellulase enzyme or providing the cellulase enzyme in the product in an amount of at least 3 g/100 g protein; and
iii. incorporating said cellulase enzyme into a composition to form a substitute food product.

2. The method of claim 1, wherein the cellulase enzyme is the main protein constituent of the substitute food product.

3. The method of claim 1, wherein the cellulase enzyme is at least partially denatured.

4. The method claim 1, wherein the cellulase enzyme is totally denatured within the substitute food product.

5. The method of claim 1, wherein the substitute food product is a curd.

6. The method of claim 1, wherein the cellulase enzyme is denatured by hydrolysis, heat-treatment, or mechanical shearing.

7. The method of claim 1, wherein the cellulase enzyme is heat-treated by heating to a temperature of from 40° C. to 100° C.

8. The method of claim 7, wherein the heat treatment is performed for 10 to 30 minutes.

9. A substitute food composition comprising at least one cellulase enzyme and one or more of: lipids, proteins, sweetening agents, and/or ash, wherein said cellulase enzyme comprises at least 3% by weight of protein in the substitute food composition.

10. The substitute food composition of claim 9, wherein the substitute food composition is an egg replacement composition comprising a cellulase enzyme that is present in the product in an amount of at least 3 g/100 g protein.

11. The composition of claim 9, wherein the composition comprises lipids.

12. The composition of claim 11 wherein the lipids are coconut fat or vegetable oil.

13. The composition of claim 9, which is a liquid composition and comprises the cellulase enzyme in a concentration of from 0.01 g/L to 1000 g/L.

14. The composition of claim 13, which comprises the cellulase enzyme in a concentration of from 60 g/L to 350 g/L.

15. The composition of claim 9, wherein said cellulase enzyme is the main protein constituent of said composition.

16. The composition of claim 9, wherein said cellulase enzyme comprises at least 5% by weight of said composition.

17. The composition of claim 9, which further comprises a mucilage formed from soaking flaxseeds.

18. A substitute dairy product formed using the composition of claim 9, which substitute dairy product is selected from a substitute curd, substitute milk, butter, cheese, yoghurt, custard, cream cheese, medium-hard cheese, hard cheese, pasta filata-type cheese, soft-ripened cheeses, and other substitute dairy products.

19. The substitute dairy product of claim 18 which is a ripened substitute cheese product or ripened substitute yoghurt product.

20. The egg replacement composition of claim 10, in the form of an egg-white substitute.

21. A substitute-egg-based food product which comprises the egg replacement composition of claim 10, further comprising one or more ingredients for a food product.

22. The substitute-egg-based food product as claimed in claim 21, which comprises the at least partially denatured cellulase enzyme in a concentration of from 6 g/100 g to 35 g/100 g.

23. The substitute-egg-based food product as claimed in claim 22, which is selected from baked products, part-baked products, ready-to-bake products, deserts, coatings, batters, pancakes, tarts, confections, or panade.

24. (canceled)

25. A substitute-egg-based food product composition that comprises the egg replacement composition of claim 10, together with one or more ingredients and in the form of a kit for a food product.

26. A process of forming a substitute egg product, wherein a cellulase enzyme is mixed with water to form a mixture and said mixture is homogenized with a fat, wherein said cellulase enzyme provides at least 3 g cellulase/100 g protein of the product.

27. The process as claimed in claim 26, wherein said cellulase enzyme is combined with water and a carbohydrate to form the mixture.

28. The process as claimed in claim 27, wherein said carbohydrate is a seed mucilage.

29. The process as claimed in claim 28, wherein said seed mucilage is a flaxseed mucilage.

30. The process of claim 26, wherein said fat is a vegetable oil, sunflower or coconut fat.

31. The process of claim 26, wherein one or more flavor modifiers, sweeteners, ash, salt, or colorants are added.
